(19) United States
(12) Patent Application Publication
(10) Pub. No.: US 2011/0072236 A1
(43) Pub. Date: Mar. 24, 2011

(54) Method for efficient and parallel color space conversion in a programmable processor

(76) Inventor: Tibet Mimar, Morgan Hill, CA (US)

(21) Appl. No.: 12/586,358

(22) Filed: Sep. 20, 2009

(51) Int. Cl. G06F 15/76; G06F 9/02

(52) U.S. Cl. 712/4; 712/E09.002

(57) ABSTRACT

The present invention relates to an efficient implementation of color space conversion in a SIMD processor as part of converting output of video decompression to interface to a display unit.

### BACKGROUND OF THE INVENTION

1. Field of the Invention

The invention relates generally to the field of processor chips and specifically to the field of single-instruction multiple-data (SIMD) processors. More particularly, the present invention relates to color space conversion in a SIMD processor.

2. Description of the Background Art

The YCbCr color space was developed as part of ITU0R BT.601 during the development of a world-wide digital component video standard. YCbCr is a scaled and offset version of the YUV color space. Y is defined to have a nominal 8-bit range of 16-235; Cb and Cr are defined to have a nominal range of 16-240. Most video compression standards such as MPEG-2, MPEG-4, H.264, and VC-1 use YCbCr color space. The displays such as CRT and LCD use RGB as the color space. This requires conversion of color space before the display interface.

If the RGB data has a range of (0-255), the following conversion equations may be used:

R=1.164*(Y−16)+1.596*(Cr−128);

G=1.164*(Y−16)−0.813*(Cr−128);

B=1.164*(Y−16)+2.018*(Cb−128);

In general, any color space conversion could be done by matrix multiplication of input component with a 4×4 color matrix. Such color space conversion is performed at the frame rate. Each matrix multiplication requires 16 multiply and 12 add operations. Thus, for a 60 Hz frame rate and 1920×1080P full HD display, this would require 60*(2 Million Pixels)*(28 operations), or 3.36 Billion operations. Such high demand of operational throughput is difficult to attain in SIMD processors, because matrix multiplications are not done efficiently for wide SIMD configurations. Wide SIMD configurations require user-defined pairing of two source vectors to efficiently implement matrix multiplications, but this is not supported in existing SIMD processor architectures.

### SUMMARY OF THE INVENTION

The invention provides a method for implementing color space conversion operations efficiently in a SIMD processor. A wide SIMD with user-defined pairing of two source vectors is used to efficiently implement general case of color space conversions using full parallelism of SIMD architecture and without requiring separate vector additions.

### BRIEF DESCRIPTION OF DRAWINGS

The accompanying drawings, which are incorporated and form a part of this specification, illustrate prior art and embodiments of the invention, and together with the description, serve to explain the principles of the invention.

FIG. 1 shows detailed block diagram of the SIMD processor.

FIG. 2 shows details of the select logic and mapping of source vector elements.

FIG. 3 shows the details of enable logic and the use of vector-condition-flag register.

FIG. 4 shows different supported SIMD instruction formats.

FIG. 5 shows block diagram of dual-issue processor consisting of a RISC processor and SIMD processor.

FIG. 6 illustrates executing dual-instructions for RISC and SIMD processors.

FIG. 7 shows the programming model of combined RISC and SIMD processors.

FIG. 8 shows an example of vector load and store instructions that are executed as part of scalar processor.

FIG. 9 shows an example of vector arithmetic instructions.

FIG. 10 shows an example of vector-accumulate instructions.

FIG. 11 shows format of matrix multiplication for general form of color space conversion.

FIG. 12 shows how input of color space conversion stored in a vector register prior to operation.

FIG. 13 shows how matrix multiplication is performed.

FIG. 14 shows the details of the vector control register for each of the stages of color space operation.

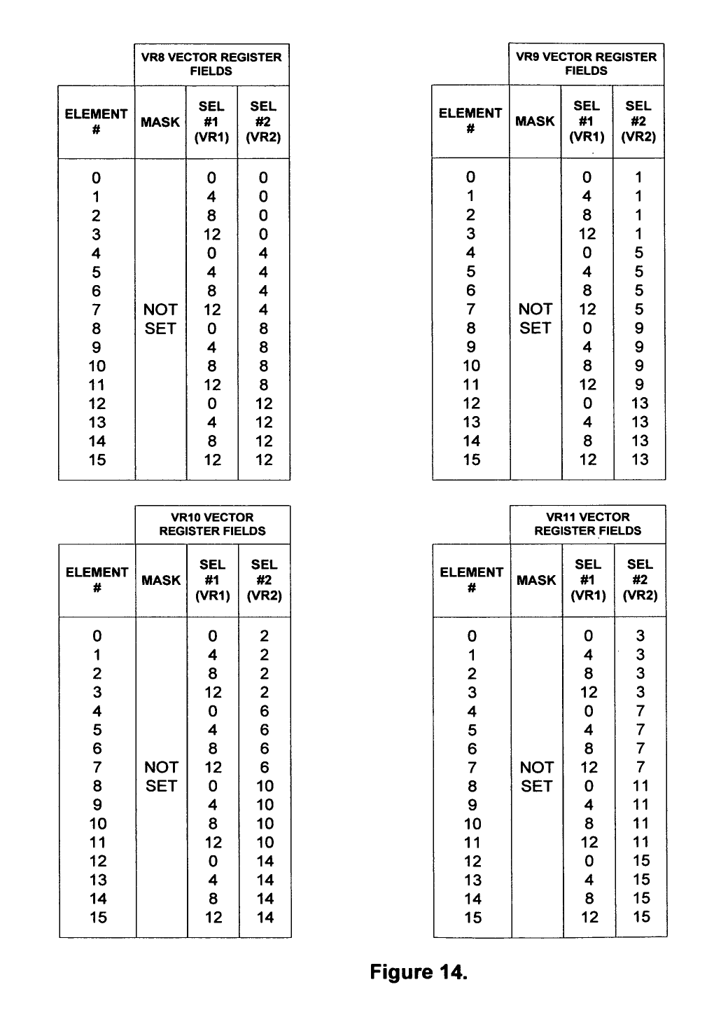

### DETAILED DESCRIPTION

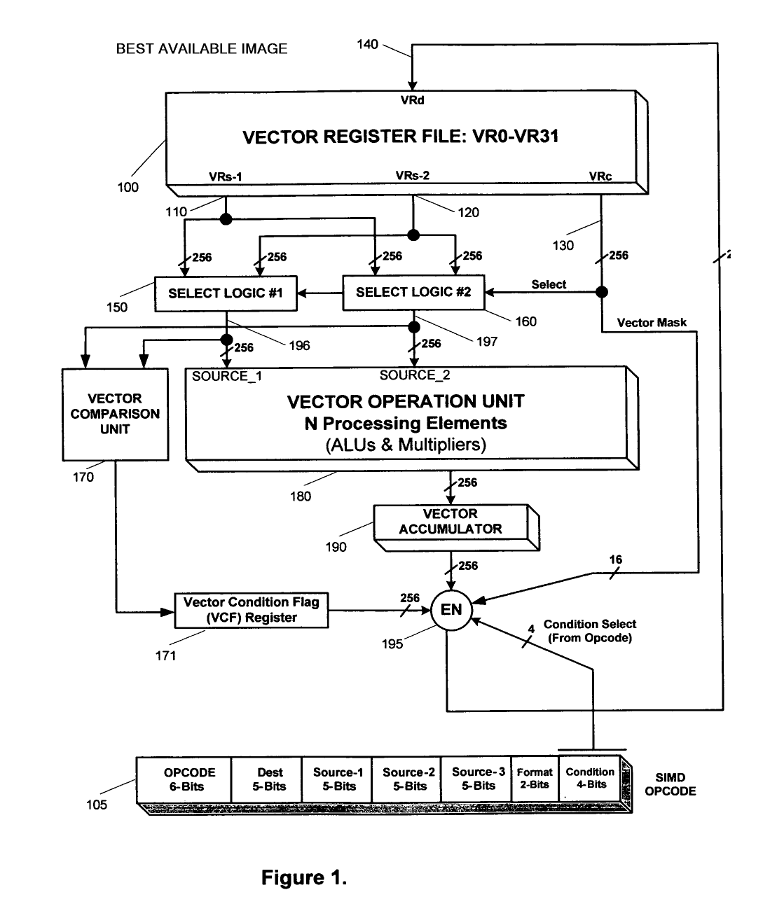

The SIMD unit consists of a vector register file 100 and a vector operation unit 180, as shown in FIG. 1. The vector operation unit 180 is comprised of plurality of processing elements, where each processing element is comprised of ALU and multiplier. Each processing element has a respective 48-bit wide accumulator register for holding the exact results of multiply, accumulate, and multiply-accumulate operations. These plurality of accumulators for each processing element form a vector accumulator 190. The SIMD unit uses a load-store model, i.e., all vector operations uses operands sourced from vector registers, and the results of these operations are stored back to the register file. For example, the instruction “VMUL VR4, VR0, VR31” multiplies sixteen pairs of corresponding elements from vector registers VR0 and VR31, and stores the results into vector register VR4. The results of the multiplication for each element results in a 32-bit result, which is stored into the accumulator for that element position. Then this 32-bit result for element is clamped and mapped to 16-bits before storing into elements of destination register.

Vector register file has three read ports to read three source vectors in parallel and substantially at the same time. The output of two source vectors that are read from ports VRs-1 110 and from port VRs-2 120 are connected to select logic 150 and 160, respectively. These select logic map two source vectors such that any element of two source vectors could be paired with any element of said two source vectors for vector operations and vector comparison unit inputs 170. The mapping is controlled by a third source vector VRc 130. For example, for vector element position #4 we could pair element #0 of source vector #1 that is read from the vector register file with element #15 of source vector #2 that is read from VRs-2 port of the vector register file. As a second example, we could pair element #0 of source vector #1 with element #2 of source vector #1. The output of these select logic represents paired vector elements, which are connected to SOURCE_1 196 and SOURCE_2 197 inputs of vector operation unit 180 for dyadic vector operations.

The output of vector accumulator is conditionally stored back to the vector register files in accordance with a vector mask from the vector control register elements VRc 130 and vector condition flags from the vector condition flag register VCF 171. The enable logic of 195 controls writing of output to the vector register file.

Vector opcode 105 for SIMD has 32 bits that is comprised of 6-bit opcode, 5-bit fields to select for each of the three source vectors, source-1, source-2, and source-3, 5-bit field to select one of the 32-vector registers as a destination, condition code field, and format field. Each SIMD instruction is conditional, and can select one of the 16 possible condition flags for each vector element position of VCF 171 based on condition field of the opcode 105.

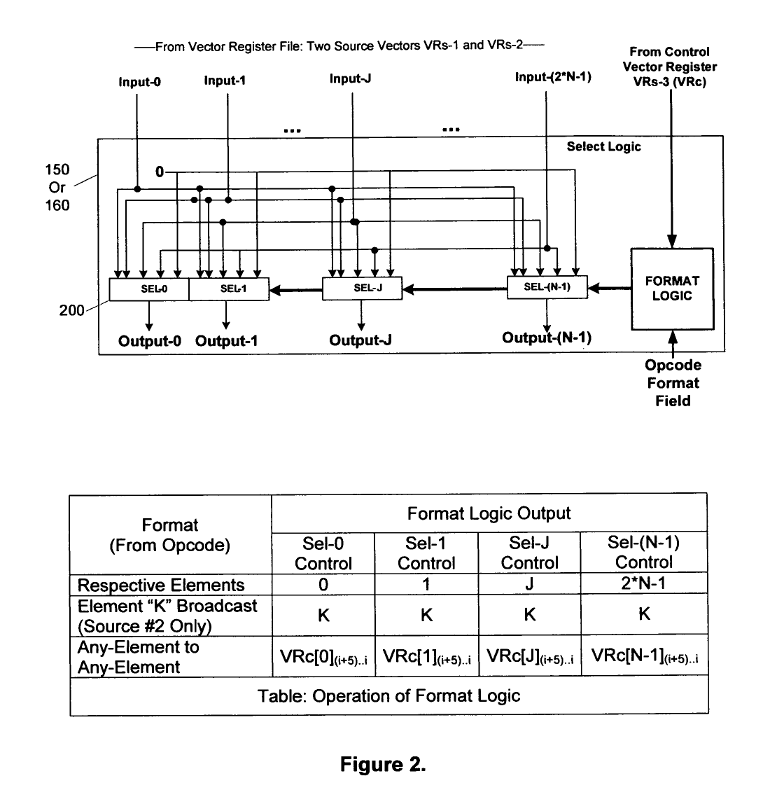

The details of the select logic 150 or 160 is shown in FIG. 2. Each select logic for a given vector element could select any one of the input source vector elements or a value of zero. Thus, select logic units 150 and 160 constitute means for selecting and pairing any element of first and second input vector register with any element of first and second input vector register as inputs to operators for each vector element position in dependence on control register values for respective vector elements.

The select logic comprises of N select circuits, where N represents the number of elements of a vector for N-wide SIMD. Each of the select circuit 200 could select any one of the elements of two source vector elements or a zero. Zero selection is determined by a zero bit for each corresponding element from the control vector register. The format logic chooses one of the three possible instruction formats: element-to-element mode (prior art mode) that pairs respective elements of two source vectors for vector operations, Element “K” broadcast mode (prior art mode), and any-element-to-any-element mode including intra elements (meanings both paired elements could be selected from the same source vector).

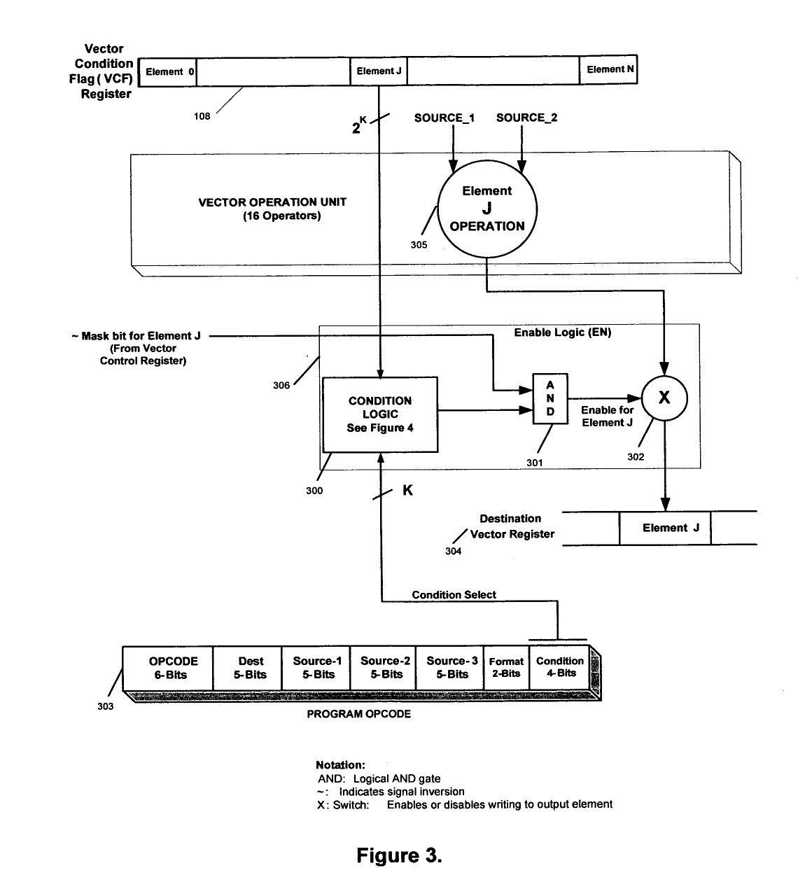

FIG. 3 shows the operation of conditional operation based on condition flags in VCF from a prior instruction sequence and mask bit from vector control register. The enable logic of 306 comprises Condition Logic 300 to select one of the 16 condition flags for each vector element position of VCF, AND logic 301 to combine condition logic output and mask, and as a result to enable or disable writing of vector operation unit into destination vector register 304 of vector register file.

In one preferred embodiment, each vector element is 16-bits and there are 16 elements in each vector. The control bit fields of control vector register is defined as follows:
Bits 4-0: Select source element from S2∥S-1 elements concatenated;
Bits 9-5: Select source element from S1∥S-2 elements concatenated;
Bit 10: 1→Negate sign of mapped source #2; 0→No change.
Bit 11: 1→Negate sign of accumulator input; 0→No change.
Bit 12: Shift Down mapped Source_1 before operation by one bit.
Bit 13: Shift Down mapped Source_2 before operation by one bit.
Bit 14: Select Source_2 as zero.
Bit 15: Mask bit, when set to a value of one, it disables writing output for that element.

| Bits 4-0 | Element Selection |
|---|---|
| 0 | VRs-1[0] |
| 1 | VRs-1[1] |
| 2 | VRs-1[2] |
| 3 | VRs-1[3] |
| 4 | VRs-1[4] |
| . . . | . . . |
| 15 | VRs-1[15] |
| 16 | VRs-2[0] |
| 17 | VRs-2[1] |
| 18 | VRs-2[2] |
| 19 | VRs-2[3] |
| . . . | . . . |
| 31 | VRs-2[15] |

| Bits 9-5 | Element Selection |
|---|---|
| 0 | VRs-2[0] |
| 1 | VRs-2[1] |
| 2 | VRs-2[2] |
| 3 | VRs-2[3] |
| 4 | VRs-2[4] |
| . . . | . . . |
| 15 | VRs-2[15] |
| 16 | VRs-1[0] |
| 17 | VRs-1[1] |
| 18 | VRs-1[2] |
| 19 | VRs-1[3] |
| . . . | . . . |
| 31 | VRs-1[15] |

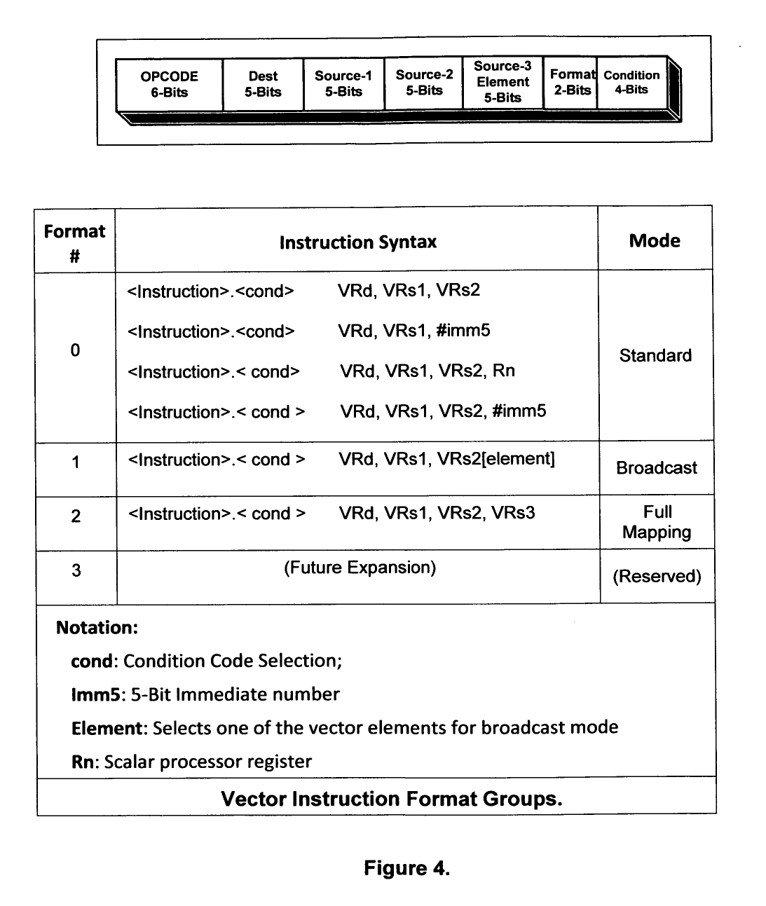

There are three vector processor instruction formats in general as shown in FIG. 4, although this may not apply to every instruction. Format field of opcode selects one of these three SIMD instruction formats. Most frequently used ones are:

| | |
|---|---|
| <Vector Instruction>.<cond> | VRd, VRs-1, VRs-2 |
| <Vector Instruction>.<cond> | VRd, VRs-1, VRs-2 [element] |
| <Vector Instruction>.<cond> | VRd, VRs-1, VRs-2, VRs-3 |

The first form (format=0) uses operations by pairing respective elements of VRs-1 and VRs-2. This form eliminates the overhead to always specify a control vector register. The second form (format=1) with element is the broadcast mode where a selected element of one vector instruction operates across all elements of the second source vector register. The form with VRs-3 is the general vector mapping mode form, where any two elements of two source vector registers could be paired. The word “mapping” in mathematics means “A rule of correspondence established between sets that associates each element of a set with an element in the same or another set”. The word mapping herein is used to mean establishing an association between a said vector element position and a source vector element and routing the associated source vector element to said vector element position.

The present invention provides signed negation of second source vector after mapping operation on a vector element-by-element basis in accordance with vector control register. This method uses existing hardware, because each vector position already contains a general processing element that performs arithmetic and logical operations. The advantage of this is in implementing mixed operations where certain elements are added and others are multiplied, for example, as in a fast DCT implementation.

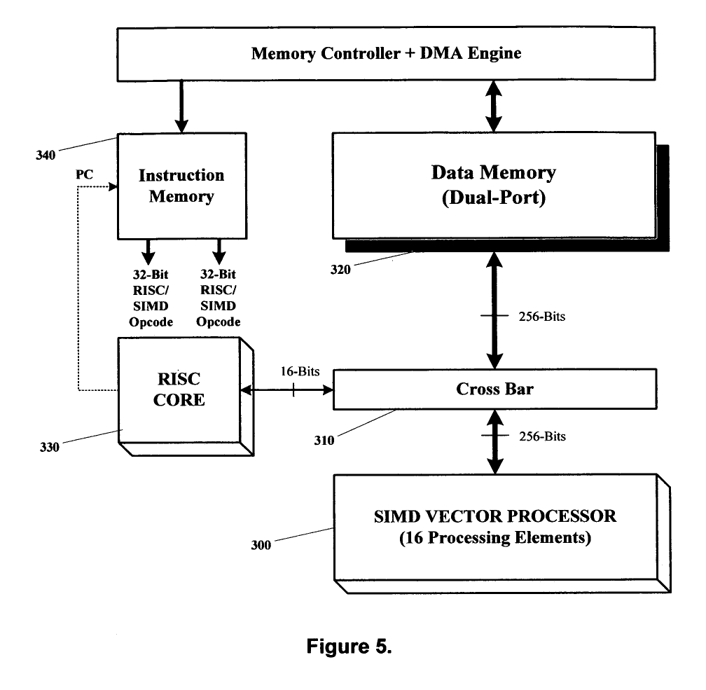

In one embodiment a RISC processor is used together with the SIMD processor as a dual-issue processor, as shown in FIG. 5. The function of this RISC processor is the load and store of vector registers for SIMD processor, basic address-arithmetic and program flow control. The overall architecture could be considered a combination of Long Instruction Word (LIW) and Single Instruction Multiple Data Stream (SIMD). This is because it issues two instructions every clock cycle, one RISC instruction and one SIMD instruction. SIMD processor can have any number of processing elements. RISC instruction is scalar working on a 16-bit or 32-bit data unit, and SIMD processor is a vector unit working on 16 16-bit data units in parallel.

The data memory in this preferred embodiment is 256-bits wide to support 16 wide SIMD operations. The scalar RISC and the vector unit share the data memory. A cross bar is used to handle memory alignment transparent to the software, and also to select a portion of memory to access by RISC processor. The data memory is dual-port SRAM that is concurrently accessed by the SIMD processor and DMA engine. The data memory is also used to store constants and history information as well input as input and output video data. This data memory is shared between the RISC and SIMD processor.

While the DMA engine is transferring the processed data block out or bringing in the next 2-D block of video data, the vector processor concurrently processes the other data memory module contents. Successively, small 2-D blocks of video frame such as 64 by 64 pixels are DMA transferred, where these blocks could be overlapping on the input for processes that require neighborhood data such as 2-D convolution.

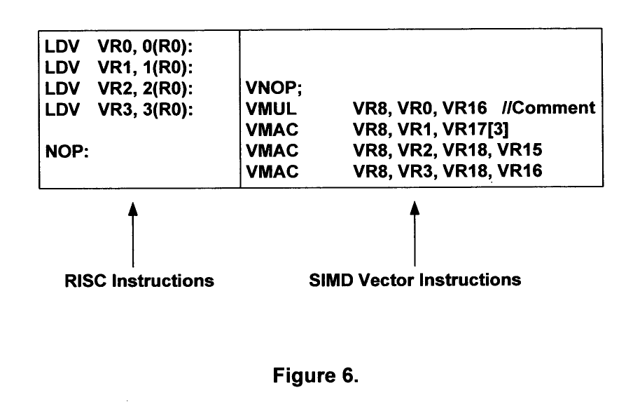

SIMD vector processor simply performs data processing, i.e., it has no program flow control instructions. RISC scalar processor is used for all program flow control. RISC processor also additional instructions to load and store vector registers. Each instruction word is 64 bits wide, and typically contains one scalar and one vector instruction. The scalar instruction is executed by the RISC processor, and vector instruction is executed by the SIMD vector processor. In assembly code, one scalar instruction and one vector instruction are written together on one line, separated by a colon “:”, as shown in FIG. 6. Comments could follow using double forward slashes as in C++. In this example, scalar processor is acting as the I/O processor loading the vector registers, and vector unit is performing vector-multiply (VMUL) and vector-multiply-accumulate (VMAC) operations. These vector operations are performed on 16 input element pairs, where each element is 16-bits.

If a line of assembly code does not contain a scalar and vector instruction pair, the assembler will infer a NOP for the missing instruction. This NOP could be explicitly written or simply omitted.

In general, RISC processor has the simple RISC instruction set plus vector load and store instructions, except multiply instructions. Both RISC and SIMD has register-to-register model, i.e., operate only on data in registers. In the preferred embodiment RISC has the standard 32 16-bit data registers. SIMD vector processor has its own set of vector register, but depends on the RISC processor to load and store these registers between the data memory and vector register file.

Some of the other SIMD processors have multiple modes of operation, where vector registers could be treated as byte, 16-bit, or 32-bit elements. The present invention uses only 16-bit to reduce the number of modes of operation in order to simplify chip design. The other reason is that byte and 32-bit data resolution is not useful for video processing. The only exception is motion estimation, which uses 8-bit pixel values. Even though pixel values are inherently 8-bits, the video processing pipeline has to be 16-bits of resolution, because of promotion of data resolution during processing. The SIMD of present invention use a 48-bit accumulator for accumulation, because multiplication of two 16-bit numbers produces a 32-bit number, which has to be accumulated for various operations such as FIR filters. Using 16-bits of interim resolution between pipeline stages of video processing, and 48-bit accumulation within a stage produces high quality video results, as opposed to using 12-bits and smaller accumulators.

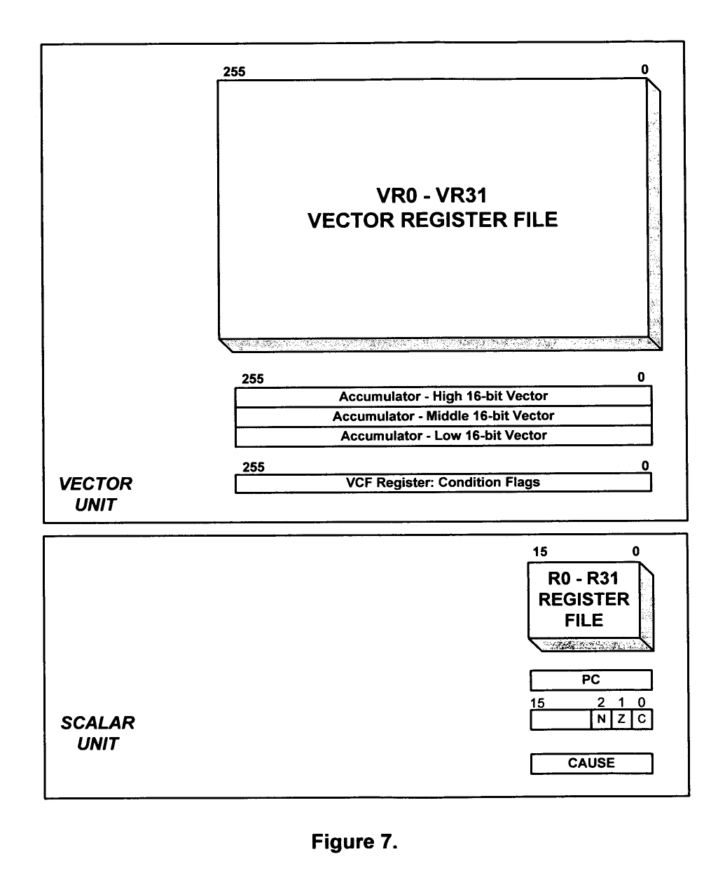

The programmers' model is shown in FIG. 7. All basic RISC programmers' model registers are included, which includes thirty-two 16-bit registers. The vector unit model has 32 vector register, vector accumulator registers and vector condition code register, as the following will describe. The vector registers, VR31-VR0, form the 32 256-bit wide register file as the primary workhorse of data crunching. These registers contain 16 16-bit elements. These registers can be used as source and destination of vector operations. In parallel with vector operations, these registers could be loaded or stored from/to data memory by the scalar unit.

The vector accumulator registers are shown in three parts: high, middle, and low 16-bits for each element. These three portions make up the 48-bit accumulator register corresponding to each element position.

There are sixteen condition code flags for each vector element of vector condition flag (VCF) register. Two of these are permanently wired as true and false. The other 14 condition flags are set by the vector compare instruction (VCMP), or loaded by LDVCR scalar instruction, and stored by STVCR scalar instruction. All vector instructions are conditional in nature and use these flags.

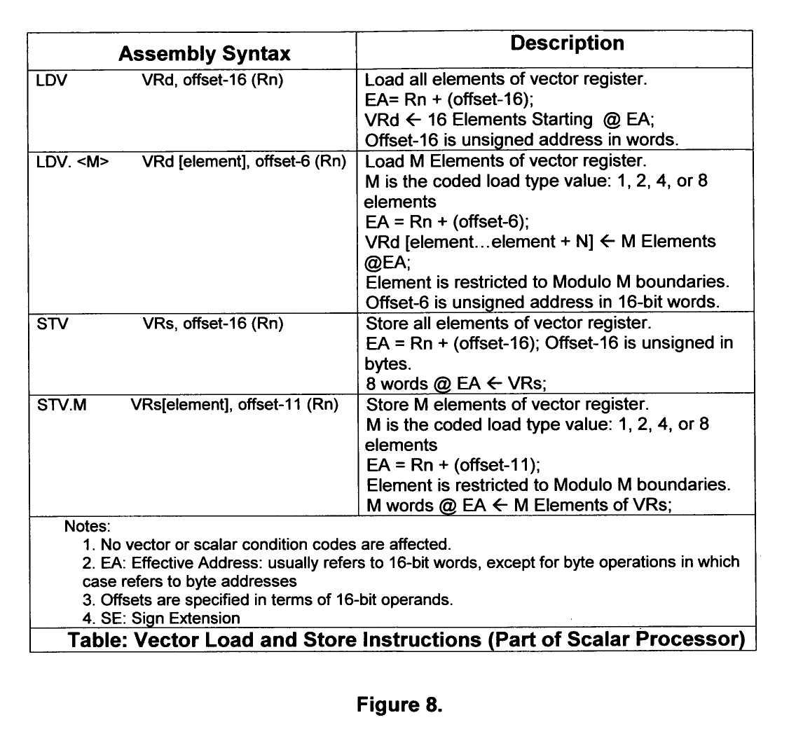

FIG. 8 shows an example of the vector load and store instructions that are part of the scalar processor in the preferred embodiment, but also could be performed by the SIMD processor in a different embodiment. Performing these by the scalar processor provides the ability to load and store vector operations in parallel with vector data processing operations, and thus increases performance by essentially “hiding” the vector input/output behind the vector operations. Vector load and store can load the all the elements of a vector register, or perform only partial loads such as loading of 1, 2, 4, or 8 elements starting with a given element number (LDV.M and STV.M instructions).

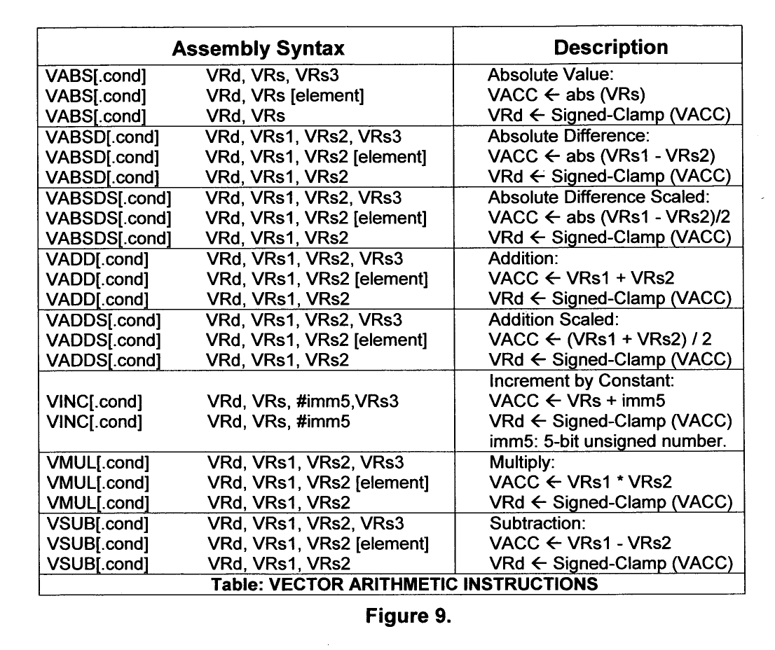

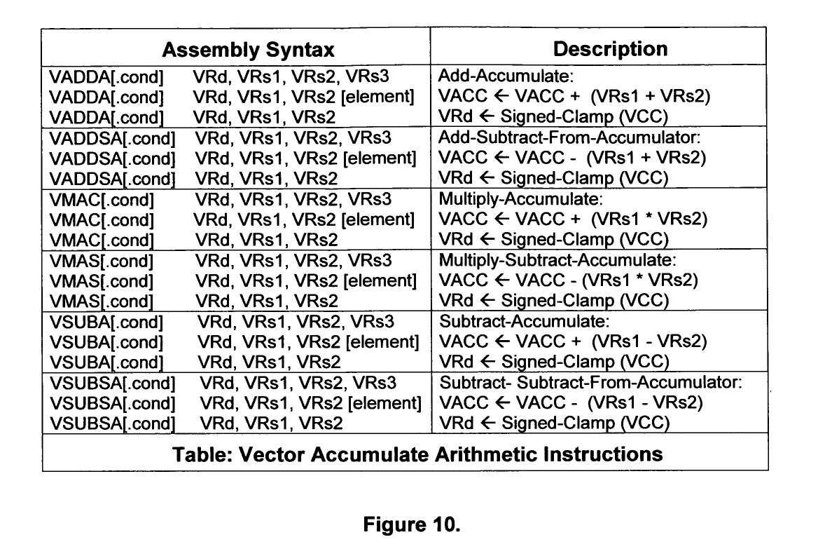

FIG. 9 shows an example of the vector arithmetic instructions. All arithmetic instructions results are stored into vector accumulator. If the mask bit is set, or if the condition flag chosen for a given vector element position is not true, then vector accumulator is not clamped and written into selected vector destination register. FIG. 10 shows an example list of vector accumulator instructions.

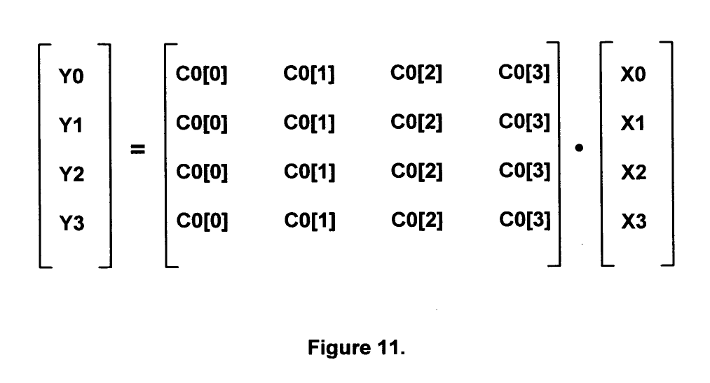

All color space conversions could be expressed in terms of matrix multiply shown in FIG. 11. Cn(m) represent color matrix transform constant values for a particular transformation. Any addition of offset could be done after the matrix multiply operation. Also, saturation is used to limit resultant values to a specific range based on, for example, whether it is a 8- or 10-bit display is used in the case of conversion to RGBA.

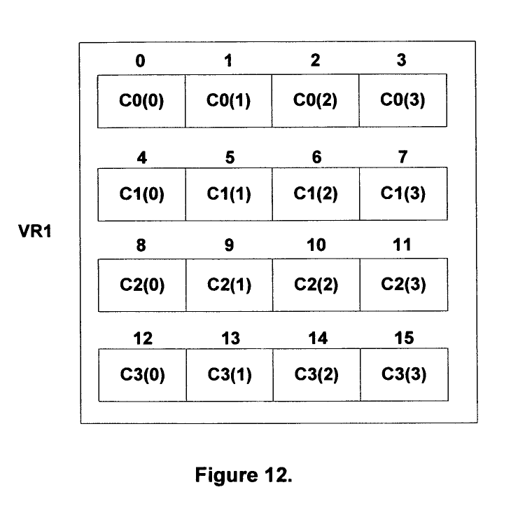

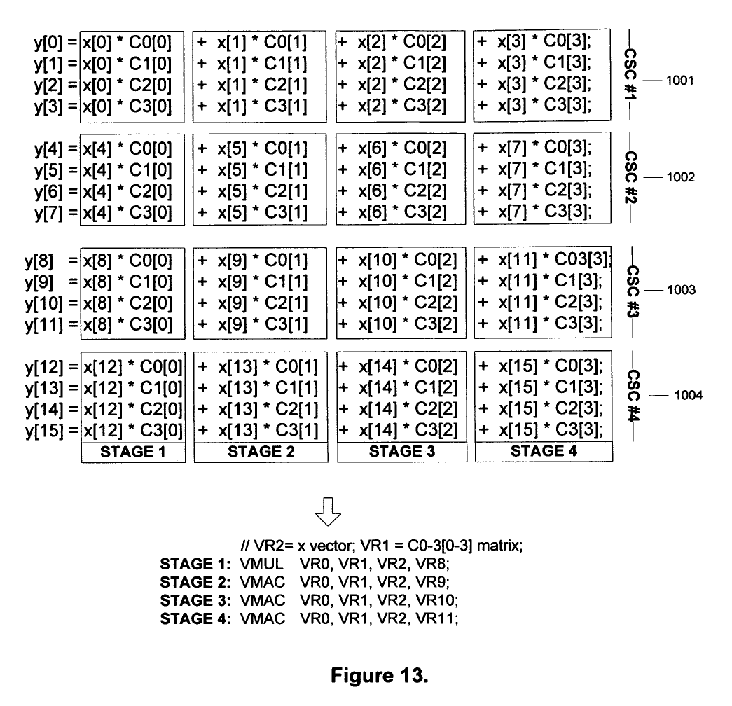

FIG. 12 shows that all elements of transformation matrix could be stored in one vector register, using preferred embodiment with 16 elements for each vector register. FIG. 13 shows that matrix multiplication is performed by multiplying first column of constant matrix Cn(m) with input vector of X[0-3] as first stage of calculation. This stage is performed using vector-multiply (VMUL) instruction. The second stage multiplies second column of Cn(m) with input vector of X[0-3] and adds to vector accumulator using vector-multiply-accumulate (VMAC) instruction. Similarly, stages 3 and 4 multiplies third and fourth columns of Cn(m) with input vector of X[0-3] and adds to vector accumulator using vector-multiply-accumulate (VMAC) instruction.

Since preferred embodiment has 16 vector elements per vector register, but input vector X[0-3] has only 4 vector elements, we perform four color-space conversion operations in parallel shown as 1301, 1302, 1303, and 1304. Thus, it takes for vector instructions to perform 4 color space conversion operations, or one vector or SIMD instruction per each color space conversion operation.

FIG. 4 shows the details of the vector control register for each of the stages of color space operation, where it is important how the vector element of two source vectors are paired for vector-multiply or vector-multiply-accumulate operations. The ability of the present invention for pairing vector elements of two source vectors provides efficient implementation of color space conversion operation. The dual-issue operation of preferred embodiment provides for vector load and store operations in parallel with vector operations, whereby no additional cycles are required for vector input/output operations. Similarly, DMA engine brings no data or takes out processed data in parallel with dual-issue RISC-plus-SIMD processors so that input/output of 2-dimensional areas of video is also concurrent with vector input/output and SIMD operations.

For a 60 Hz frame rate and 1920×1080i full HD display, this would require 60 frames/sec*(1 Million Pixels/frame), or 60 Million pixels/sec. This would equate to 60 Million SIMD instructions per second approximately. For a SIMD that is running at 500 MHz clock rate, this means using 60/500, or 12 percent of available operations. For a standard definition video with 640×480 resolution, this would equate to (640×480×60), or 18.5 Million operations, or 3.7 percent of available operations of preferred embodiment in a programmable processor.

1. (canceled)

2. A processor for performing digital signal processing algorithms in parallel, the processor comprising:
a first vector register and a second vector register for holding respective first source vector operand and second source vector operand on which a vector operation is to be carried out, wherein each of said first vector register and said second vector register holds a plurality of vector elements of a predetermined size, each of said plurality of vector elements defining one of a plurality of vector element positions;
at least one control vector register for holding a third source vector operand;
a plurality of operators associated respectively with said plurality of vector element positions for carrying out said vector operation, each of said plurality of operators having a first input and a second input;
a first select logic coupled to said first input for each vector element position for selecting from a first group of at least elements of said first source vector in accordance with said at least one control vector register;
a second select logic coupled to said second input for each vector element position for selecting from a second group of at least elements of said second source vector in accordance with said at least one control vector register; and
a vector accumulator coupled to output of said plurality of operators for storing output or performing accumulation of partial results in accordance with a vector instruction.

3. The processor according to claim 2, wherein both of said first group and said second group includes vector elements of said first source vector operand and said second source vector operand.

4. The processor according to claim 2, further including:
means for multiplying first column of a constant matrix with first row of an input matrix and storing partial results into said vector accumulator, said input matrix is comprised of one or more sets of input vectors including color components to be converted.
means for multiplying second and subsequent columns of said constant matrix with respective second and subsequent rows of said input matrix and accumulation of partial results by said vector accumulator.

5. The processor according to claim 2, wherein number of vector elements for each vector register is 16, and four sets of color space conversion operations are completed in four clock cycles.

6. The processor according to claim 2, further including means for performing one or more color space conversion in parallel.

7. The processor according to claim 2, wherein number of vector elements for each vector register is an integer between 2 and 1025.

8. The processor according to claim 2, wherein each vector element size is one of 16-bits, 32-bits, and 64-bits.

9. The processor according to claim 2, wherein each vector element stores a fixed-point or a floating-point number.

10. A method for parallel and programmable implementation of math processes, the method comprising:
storing a first source vector to be a first operand of a vector instruction;
storing a second source vector to be a second operand of said vector instruction;
storing a control vector to be a third operand of said vector instruction;
said vector instruction performing a set of steps comprising:
selecting, in accordance with a first designated field of each vector element of said control vector, from a first group comprising elements of said first source vector, to generate a first mapped vector, said first mapped vector being the same size as said first source vector and said second source vector;
selecting, in accordance with a second designated field of each vector element of said control vector, from a second group comprising elements of said second source vector, to generate a second mapped vector, said second mapped vector being the same size as said first source vector and said second source vector; and
performing the vector operation of said vector instruction on respective vector elements of said first mapped vector and said second mapped vector to produce respective resulting elements of an output vector.

11. The method according to claim 10, further including a step of adding or storing said output vector to a vector accumulator in accordance with said vector instruction, wherein a vector multiply instruction stores said output vector to said vector accumulator, and a vector multiply-accumulate instruction adds said output vector to said vector accumulator.

12. The method according to claim 11, further including a step of clamping output of said vector accumulator using saturation arithmetic before storing it to a destination vector.

13. The method according to claim 10, wherein said vector instruction is a vector-multiply instruction which performs all respective steps in a single clock cycle.

14. The method according to claim 11, wherein said vector multiply-accumulate instruction which performs all respective steps in a single clock cycle.

15. The method according to claim 11, further including steps for performing color space conversion of one or more sets of an input vector comprised of color components in parallel.

16. The method according to claim 11, further including steps comprising:
Loading multiple said control vectors, at least one said control vector loaded for each pairing of elements of a numbered column of constant matrix and respective equal numbered row of an input matrix in accordance with different steps of matrix multiplication requirements;
Performing multiplication of a first column of constant matrix with first row of an input matrix, as part of matrix multiplication, using one or more said vector multiply instructions with respective said control vector selected, said input matrix is comprised of one or more columns of input vectors, each of said input vectors is comprised of one set of color components;
Performing multiplication of second columns of said first constant matrix with second row of an input matrix using one or more said vector multiply accumulate instructions with respective control vector selected; and
Repeating step of performing multiplication of second column for the rest of the columns of said constant matrix.

17. The method according to claim 11, wherein said first source vector and said second source vector has 16 vector elements, and performing a color space conversion of four input vectors in parallel, each with three color components and an alpha component is performed using one said vector multiply instruction and three of said vector multiply-accumulate instructions with proper control vector loaded in accordance with matrix multiplication requirements for each said vector instruction.

18. The method according to claim 10, wherein three vector instruction formats are supported, in accordance with a format field of instruction word, in pairing elements of said first and second source vector operands: respective element-to-element format as default, one-element broadcast format, and any-element-to-any-element format requiring a third source vector operand.
